(19) United States
(12) Patent Application Publication
(10) Pub. No.: US 2007/0146864 A1
(43) Pub. Date: Jun. 28, 2007

(54) Magneto-optical device

(75) Inventors: Rudolf Johan Maria Vullers, Eindhoven (NL); Martinus Bernardus Van Der Mark, Eindhoven (NL); Bob Van Someren, 's-Hertogenbosch (NL); Ferry Zijp, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/561,855

(22) PCT Filed: Jun. 22, 2004
(86) PCT No.: PCT/IB04/50959

§ 371 Date: Dec. 21, 2005

(30) Foreign Application Priority Data
Jun. 25, 2003 (EP) 03101884.9

(51) Int. Cl. G02B 26/00

(52) U.S. Cl. 359/291

(57) ABSTRACT

Magneto-optical device comprising a magneto-optical read and/or write head with a coil (5), and a means for generating a laser beam (1), wherein the laser beam is passed through an aperture (12) in the coil (5) during operation, characterized in that the coil holder comprises a recess at or around the position of the optical center of the coil, and a lens (4) extends, viewed from the disk, behind the coil, overlapping the coil at least partly.

The invention relates to a magneto-optical device comprising a magneto-optical read and/or write head with a coil on a coil holder, and a means for generating a laser beam, wherein the laser beam is passed through the coil during operation.

An embodiment of a system of the type mentioned in the opening paragraph is known from U.S. Pat. No. 6,069,853.

In such devices optical recording techniques are combined with a magneto-optical head that is brought close to a recording layer on a disk during operation. Polarized laser light is used to read and/or write on the disk. The laser beam is passed through the coil, which is e.g. incorporated on a slider or on an actuator. New generations of optical recording disks have ever larger data capacity and smaller bit sizes. There is a tendency for the wavelength of the optical readout to decrease and for the numerical aperture (NA) of the optical pick up unit (OPU) to increase in each new generation. Focal length and working distance decrease, and tilt margins become ever more stringent. For future generations of optical storage systems, the numerical aperture of the objective will rise to NA=0.85, or even NA=0.95, to improve the resolving power. Despite this tendency of the objective to increase in weight, however, the increasing demand for high data rates and short access times forces the total mass of the objective to shrink. With NA kept constant, this can only be accomplished if the focal length and hence the free working distance (FWD) is reduced. The head containing the coil is manufactured by means of thin film techniques. The coils are made on top of a wafer (e.g. glass) and are embedded in oxide (e.g. Al₂O₃). The free working distance (FWD) between head and disk is less than 20 microns and, as explained above, decreasing for novel designs. It has been found that a twofold problem arises for such small free working distances: firstly, water condenses on the head and secondly, a deposit is left after evaporation of the water. The water and the deposit adversely affect the operation of the head, which is especially relevant since the optical requirements of the head and the laser power are continually increasing.

It is an object of the invention to provide a magneto-optical device in which the above problem is alleviated.

To this end, the coil holder comprises a recess with a recess depth at or around the position of the center of the coil, and a lens extends, behind the coil, viewed from the disk, overlapping the coil at least partly.

Water and contamination cannot be deposited on the surface of the head if there is no surface. Water will now be deposited on the surfaces closest to the disk, which are outside the light path, without interfering with the light path. It can no longer block or disturb the light path, nor can any contamination be left in the light path after evaporation of the water. A lens is positioned on the coil holder, which lens is positioned behind the coil and also overlaps the coil. This allows the coil to be positioned as close as possible to the disk, thus enabling a relatively large NA while yet allowing a strong magnetic field to be achieved.

Preferably, the coil holder comprises a recess that extends only at the center of the coil for reasons of mechanical stability.

The invention also relates to a read and/or write head as defined in claim 7.

These and other aspects of the invention are apparent from and will be elucidated, by way of example, with reference to the embodiments described hereinafter.

### IN THE DRAWINGS

FIGS. 1A and 1B schematically illustrate two designs of heads for magneto-optical devices.

FIG. 2 schematically illustrates one of the designs of FIG. 1 in more detail.

FIG. 3 schematically illustrates one of the designs of FIG. 1 in more detail.

FIG. 4 gives a top view of a coil showing the aperture through which a laser beam is passed during operation.

FIG. 5 schematically illustrates in cross-section the light path of a laser beam through the coil.

FIGS. 6A to 6C illustrate the occurrence of water condensation on the holder.

FIGS. 7A to 7D illustrate several designs of a coil holder, wherein FIGS. 7A and 7D illustrate designs outside the scope of the invention, and FIGS. 7B and 7C designs embodying the invention.

FIGS. 8 and 9 illustrate various designs of a coil holder within the concept of the invention.

The Figures are not drawn to scale. Generally, identical components are denoted by the same reference numerals in the Figures.

The present invention is applicable to each and any type of magneto-optical device having a read and/or write head and a laser which passes through a coil during operation. Whether the magneto-optical device is of the so-called Far Field type and whether or not use is made of a slider or of an actuator is not relevant to the invention.

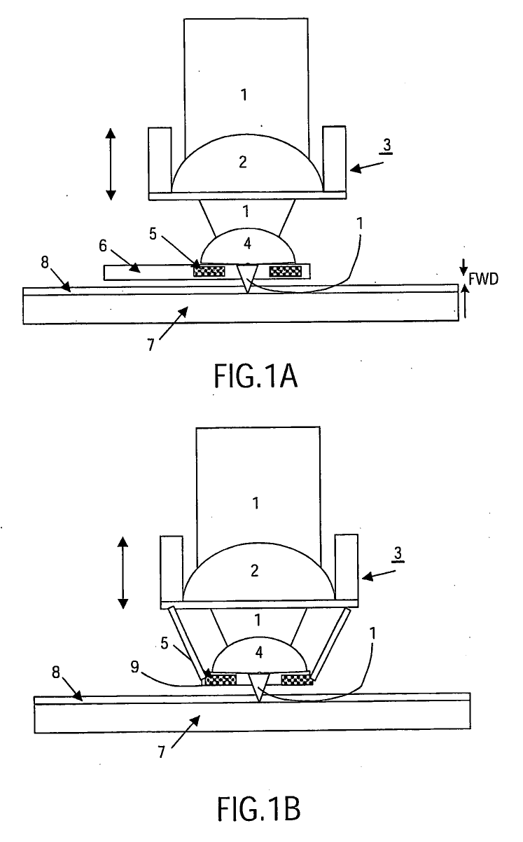

FIGS. 1A and 1B illustrate two types of arrangements. In both arrangements a laser beam 1 during operation passes through an objective lens 2 on a holder 3 and through a second lens 4 so as to be focused on a disk 7. The disk 7 is provided with a cover layer 8. The laser beam 1 is passed through a coil 5. FIG. 1A shows a type of read and/or write head of the so-called slider type, in which the second lens 4 and coil 5 are provided on a slider 6. FIG. 1B shows a head of the so-called actuator type in which the lens 4 and coil 5 are provided on and/or in a glass wafer 9. The Free Working Distance FWD is the distance between the holder 3 and the disk 7.

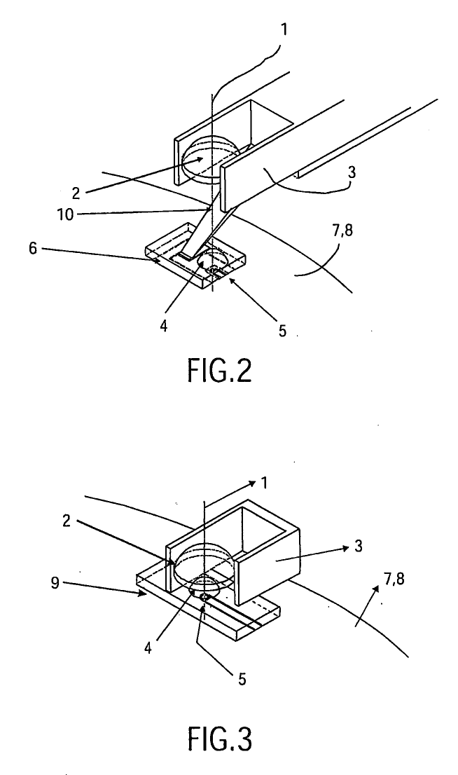

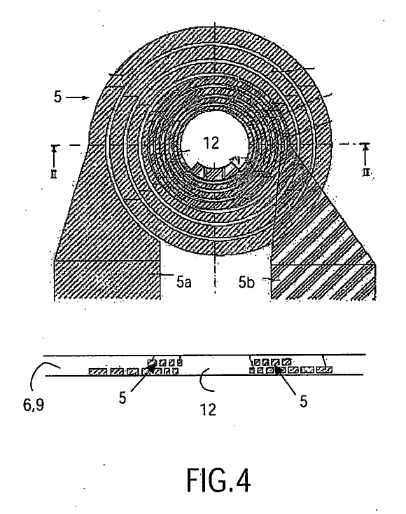

FIG. 2 shows in more detail a head of the type shown in FIG. 1A. The suspension 10 of the slider is shown in this Figure. FIG. 3 shows in somewhat more detail a head of the type shown in FIG. 1B.

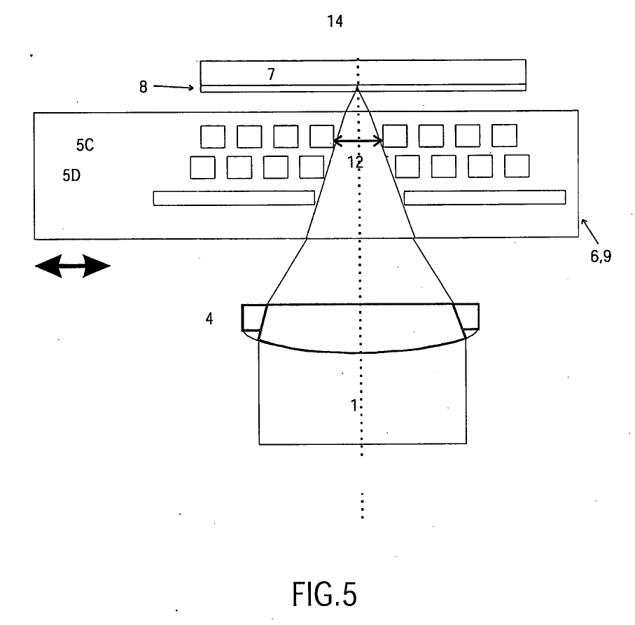

In all types the head comprises a coil 5. FIG. 4 shows a coil 5 in more detail. The coil comprises two leads 5a and 5b and an aperture 12 through which the laser beam is passed during operation. The coil is part of, applied on, or embedded in the slider 6 or wafer 9.

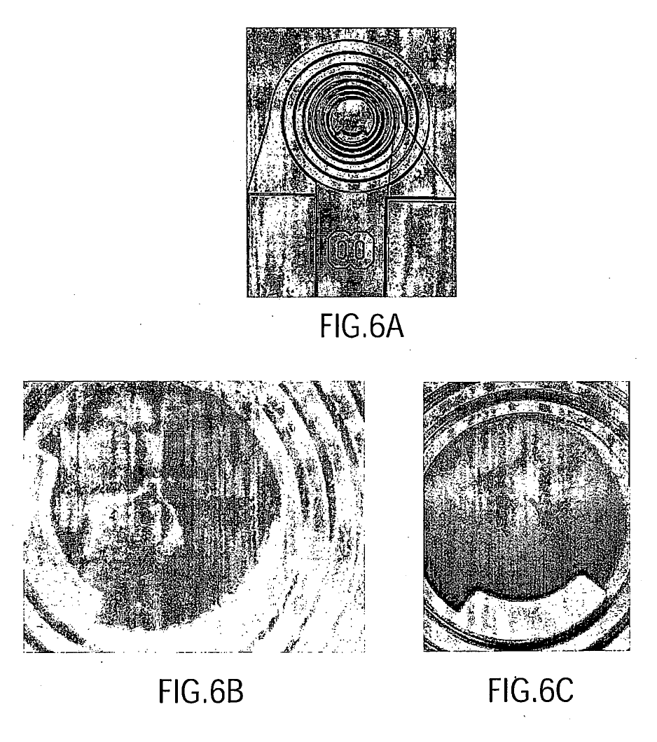

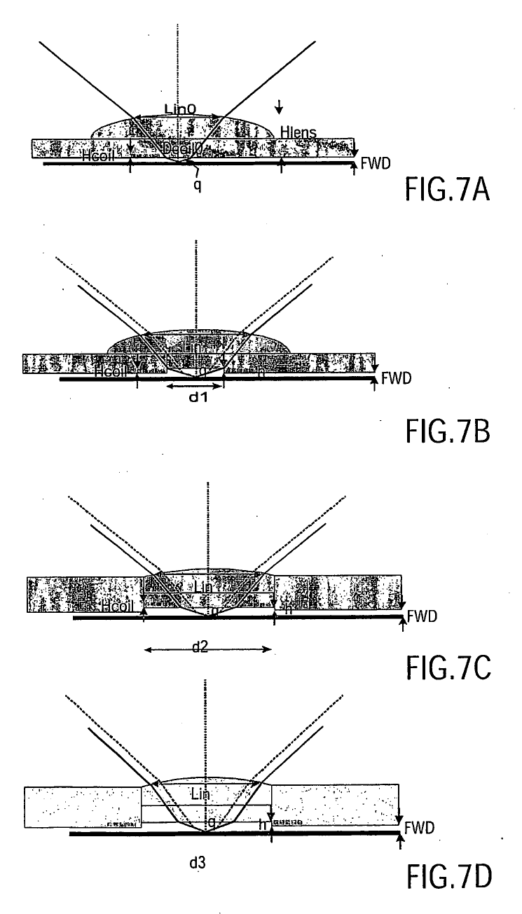

The head containing the coil is produced by thin film techniques. The coils are made on top of a wafer (e.g. glass) and are embedded in oxide (e.g. Al₂O₃). FIG. 5 is a schematic drawing of the head when in use. The free working distance (FWD) between head and disk is less than 20 microns. It has been found that working with this FWD poses a problem in optical recording. The heat generated by the laser spot at the disk causes the evaporation of water inside or on the surface the disk. This water vapor will flow from the disk towards the head. Since the head has a much lower temperature than the disk, the water will condense on the head. This is shown in FIGS. 6A, 6B and 6C. The laser light is directed through the center of the coil (A). In (B) the water is clearly visible. When the laser is turned off, the water will evaporate after some time and some contamination will eventually be left (encircled in C).

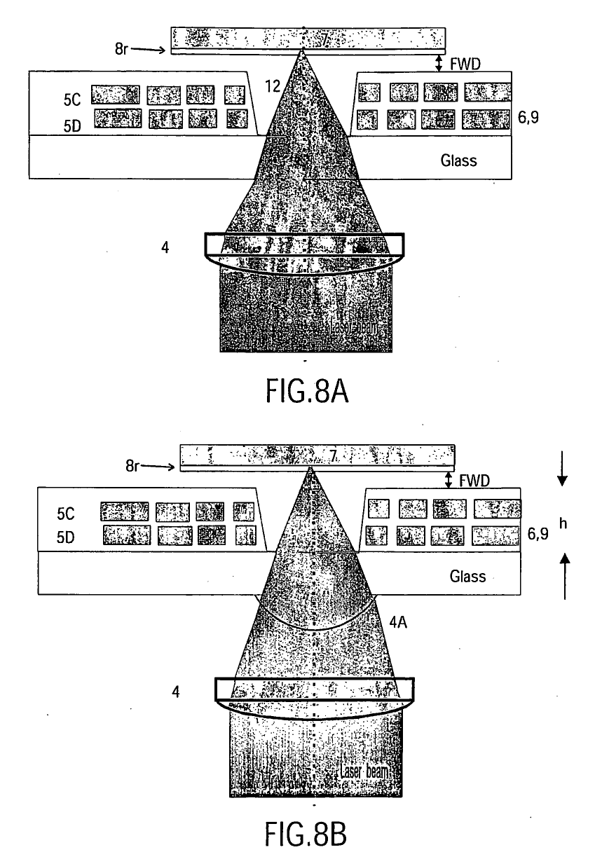

FIG. 7 illustrates several designs. The designs schematically shown in FIGS. 7A and 7D do not represent embodiments of a coil holder for a device in accordance with the invention, the designs schematically shown in FIGS. 7B and 7C do represent embodiments of coil holders for a device in accordance with the invention.

In the design shown in FIG. 7A, the coil holder does not comprises a recess or hole (hole within the concept of the invention being a specific type of recess) at or near the center of the coil 5.

A number of aspects are of importance for the design:
The diameter of the coil center Dcoil;
The Free Working Distance FWD;
The numerical aperture NA (defined by the angle θ);
The energy efficiency;
The depth of the recess h.

The energy efficiency of the coil decreases as the hole in the coil becomes larger, and also as the distance between the coil and the disk becomes larger. The problem as explained above is the condensation of water. A reduction in efficiency increases the amount of heat that has to be used, and thus increases the current density and temperature of the coil, which will eventually lead to the breakdown of the coil when the current density or the temperature has passed a critical value. This would necessitate the use of coil with more or larger windings, thus increasing the inductance and capacitance of the coil dramatically, which in turn will decrease the resonance frequency (and thus the bandwidth) of the coil.

FIG. 7A illustrates a standard design. In FIG. 7A, the coil comprises a coil center. As explained, the heat generated by the coil causes water to evaporate with the problems mentioned. In FIG. 7B a recess is made in the coil. This slightly increases the coil center diameter (thus dl is larger than Dcoil0). However, the positive effect of a reduction of water condensation on the center outweighs the decrease in power efficiency. FIG. 7C illustrates a further embodiment of the invention. It is apparent that, whereas in FIG. 7B a recess is made in the center of the coil, in FIG. 7C the coil itself is recessed with respect to the rest of the holder. This means that the coil center diameter is slightly larger and that the distance between the coil and the disk is increased from FWD to FWD+h. The latter also leads to a decrease in power efficiency, since the distance between the coil and the disk increases. Depending on the distance h and the coil diameter, however, advantages outweighing the disadvantages may still be obtained. Preferably, the recess depth h is less than 2 FWD, preferably less than FWD, but preferably more than ½ FWD. The design schematically shown in FIG. 7B is preferred to the design shown in FIG. 7C for reasons of power efficiency. The recess depth h is preferably within the ranges (with respect to FWD) indicated above, however, also for the designs of FIG. 7B.

In the design shown in FIG. 7D, finally, the coil 5 is placed around an aperture in which the lens 4 is positioned, but in this design the power efficiency is so much decreased that the advantages no longer outweigh the disadvantages, although the center of the coil is recessed. The lens and coil are so positioned that they no longer overlap. With overlapping is meant that, seen from the disk, the lens extends at least partly behind the coil turn(s), i.e. the diameter of the lens is larger than the diameter of the aperture in the coil. In the design in FIG. 7D, the diameter of the lens is less than the diameter of the center of the coil, so the lens fits inside the aperture in the coil. As a consequence, compared with the designs of FIGS. 7B and 7C, the diameter of the aperture in the coil is increased, the coil is larger, and a considerable reduction in efficiency occurs, with the above-mentioned disadvantages. The use of the word “diameter” is to be seen in a non-restrictive manner, as indicating a dimension or size, not necessarily restricting the elements (lens, aperture, coil) to which the word applies to purely circular or cylindrical objects.

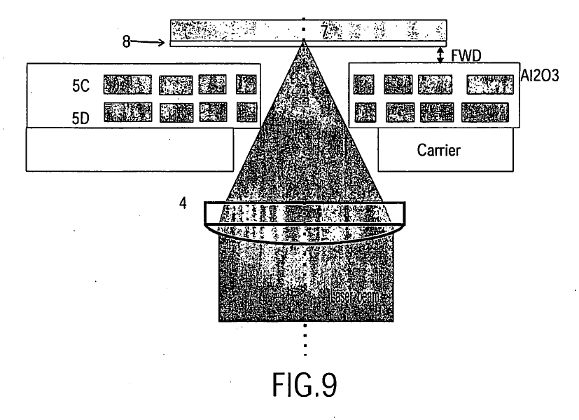

FIGS. 8A, 8B and 9 schematically illustrate various embodiments of a coil holder for a device in accordance with the invention.

In FIGS. 8A and 8B, a hole is made in the optical center of the coil. Water and contamination cannot be deposited on the surface of the head if there is none present: water will now be deposited on the surface closest to the disk, either on the side walls or on top of the coils, next to the hole. It can no longer block or disturb the light path. The depth of the coil depends on the inner diameter of the coil. In FIG. 8A, a slightly more complex lens system is used comprising a lens 4 and a lens 4A. The coil is e.g. made of Cu, covered by Al₂O₃. A hole can be etched in oxide by either wet or dry etching. The thickness of the coil layer is e.g. 4 microns, 2 microns of oxide between the layers 5C and 5D, and 0.5-micron oxide on layer 5C.

FIG. 9 shows yet a further embodiment. The substrate supporting the coil now also has a hole. This can be manufactured in two ways:
1. The coil is manufactured on a substrate and after processing of the front side, a hole is processed in the rear side of the substrate. This hole may be made by a combination of a “rough” technique (e.g. powder blasting) and wet or dry etching. Since the laser light only travels through air, opaque substrates may also be used, especially Si. This would have the advantage that the coil can be made directly on an IC.
2. The coil is manufactured using “Silicon on Anything” (as proposed in international patent application WO200213188). After the fabrication of the coil with a hole, the whole can be put on a carrier.

This embodiment has the advantage that a carrier can be chosen which has a better thermal conductance γ (W/m²K) than the widely used glass. Glass has typical value for γ of 1, while SiO₂ is 4 to 8, Al₂O₃ is around 25, and SiC is 125. The better the thermal conductance, the better the coil will be cooled, and thus the higher the current that can be used compared with a normal coil. This would more than counteract the negative effect of the larger coil diameter that is necessary for a coil with a hole compared with a normal coil.

Summarizing the invention can be described as follows:

In a magneto-optical device is which a laser beam is passed through a coil during operation, the coil holder comprises a recess at or around the position of the optical center of the coil, and a lens extends, viewed from the disk, behind the coil, overlapping the coil at least partly.

It will be appreciated by those skilled in the art that the present invention is not limited by what has been particularly shown and described hereinabove. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

1. Magneto-optical device comprising a magneto-optical read and/or a write head with a coil holder (6, 9) comprising a coil (5), and a means for generating a laser beam (1), wherein the laser beam is passed through an aperture (12) in the coil (5) during operation, which coil holder comprises a recess with a recess depth (h) at or around the position of the center of the coil, and a lens (4) extends, viewed from the disk, behind the coil so as to overlap the coil at least partly.

2. Magneto-optical device as claimed in claim 1, characterized in that the recess is restricted to an area within the aperture in the coil.

3. Magneto-optical device as claimed in claim 1, characterized in that the coil (5) is positioned in the recess.

4. Magneto-optical device as claimed in claim 1, characterized in that the depth of the recess (h) is less than twice the free working distance (FWD).

5. Magneto-optical device as claimed in claim 4, characterized in that the depth of the recess is less than the free working distance.

6. Magneto-optical device as claimed in claim 4, characterized in that the depth of the recess (h) is more than half the free working distance.

7. Read and/or write head presenting all the features of the head disclosed in claim 1 and being thus constructed and evidently intended for use in the magneto-optical device as claimed in claim 1.
